(19) United States
(12) Patent Application Publication
(10) Pub. No.: US 2010/0242653 A1
(43) Pub. Date: Sep. 30, 2010

(54) Deflecting body for a ball screw

(75) Inventors: Dieter ADLER, HERZOGENAURACH (DE); Mario KREUTZER, SONNEBERG (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER TECHNOLOGIES GMBH & CO. KG, Herzogenaurach (DE)

(21) Appl. No.: 12/706,940

(22) Filed: Feb. 17, 2010

(30) Foreign Application Priority Data
Feb. 18, 2009 (DE) 10 2009 009 522.5

(51) Int. Cl. F16H 25/24; F16H 25/22

(52) U.S. Cl. 74/424.87

(57) ABSTRACT

A deflecting body for a ball screw, which has two body parts to be connected to one another which delimit a deflecting channel which carries rolling bodies. Latching or jamming projections are provided on one or both body parts. The latching or jamming projections, in the assembled final position, latch or are jammed in a frictionally engaging manner in latching or jamming receptacles provided on the other body part.

### FIELD OF THE INVENTION

The invention relates to a deflecting body for a ball screw, comprising two body parts to be connected to one another which delimit a deflecting channel which guides rolling bodies.

### BACKGROUND OF THE INVENTION

A ball screw as is known, for example, from DE 10 2004 023 353 A1 comprises a threaded spindle which is provided with an external thread, a threaded nut which is seated on said threaded spindle and is provided with an internal thread, and balls which are carried in the one or more ball channels formed by means of the threads, on which balls the threaded nut runs. The threaded nut has provided on it at least one deflecting body which serves to continuously return the balls, that is to say to return one or more thread flights as viewed in the axial direction in order to ensure that the balls do not fall out in the event of a sufficient adjustment of the nut. The deflecting body is inserted into the nut and is thus moved with the latter. Said deflecting body has a deflecting channel having a run-in section into which the balls run proceeding from the ball channel, the actual axially transferring channel section and a run-out section via which the balls run back into the ball channel.

In addition to single-piece deflecting bodies, DE 10 2004 023 353 A1, for example, also discloses a two-part deflecting body comprising a first and a second body part. In each case one deflecting channel half is provided on the two body parts which are generally produced from plastic, which deflecting channel halves complement one another so as to form the deflecting channel when assembled. For reasons of transport security, that is to say to ensure that two body parts which form a deflecting body are not present in loose form and can be lost, and to ensure that they can be assembled into the threaded nut, the body parts are fixedly connected to one another, for which purpose, in known two-part deflecting bodies, cylindrical projecting pegs and cylindrical peg holes which receive said pegs are provided on the individual body parts on those end surfaces of the body parts which are situated opposite one another and are to be connected to one another. The diameter of the pegs is slightly larger than the diameter of the peg receptacles. The connection takes place by virtue of the two body parts being ultrasound-welded to one another. For this purpose, the body parts are heated in the region of the end surface, in particular, the body part which has the pegs is heated in the region of the pegs, using a suitable ultrasound welding unit, such that the plastic material becomes soft. This makes it possible for the pegs, which are slightly larger in diameter but which are now soft and deformable, to be inserted into the peg receptacles which are slightly smaller in diameter. The heating is continued until the pegs are fully inserted and the body parts are fully assembled. The heated, soft plastic material subsequently hardens again such that a firm, virtually cohesive connection is provided between the pegs and the surrounding body material. After said welding process, it is necessary to check the connection to ensure that the two body parts are also connected to one another in exactly the correct position and that the welding was successful. This connecting process is cumbersome, and special precautions must be taken for the welding and subsequent checking, which firstly takes up a considerable amount of time and secondly also entails a considerable cost expenditure.

### SUMMARY OF THE INVENTION

Therefore, the invention is based on the problem of specifying a two-part deflecting body whose body parts can in a simple manner be connected to one another firmly, that is to say so as to be secured for transport and in a manner suitable for assembly.

To solve said problem, it is provided according to the invention in a deflecting body of the type specified in the introduction that latching or jamming projections are provided on one or both body parts, which latching or jamming projections, in the assembled final position, latch in a positively locking manner or are jammed in a frictionally engaging manner in latching or jamming receptacles provided on the other body part.

In the plastic body according to the invention, the two body parts are fastened to one another purely mechanically such that, if latched, they can no longer be pulled apart or can be pulled part only if the latching connection is released in complex fashion, and if jammed, they can be pulled apart only with increased force expenditure. The required firm connection, which permits simple transportation and also simple assembly, is realized as a result of the latching or jamming action. The latching or jamming projections required for the snapping or latching and also the corresponding latching or jamming receptacles can, if the body parts are produced in a conventional manner by means of plastic injection molding, be easily produced by means of corresponding shaping of the injection-molding dies. The connection of the body parts is however considerably simpler by means of a mere plugging-together action, and the complex ultrasound welding process may particularly advantageously be dispensed with, which makes the connection significantly faster and inexpensive.

If latching projections are provided as fixing elements, these are expediently designed as resilient latching lugs which latch into correspondingly undercut latching receptacles. It is preferable for two or more latching lugs to be arranged adjacent to one another and to engage into a common latching receptacle. It is expedient here for example for three or four latching lugs to be arranged and formed in a circular arrangement and with a circular geometry in the region of their latching sections, which engage into a round undercut receptacle. It is also possible for only two such latching lugs to be provided adjacent to one another, which latching lugs are of rounded design in the region of their latching sections and interact with a circular latching receptacle, and it is of course also possible for angular latching lugs or latching sections and angular latching receptacles to be actualized.

If jamming projections are provided as fixing elements, these are expediently designed as resilient jamming tongues, with two or more jamming tongues being arranged adjacent to one another and engaging into a common jamming receptacle. Here, too, a virtually circular arrangement of the jamming tongues and a curved design of their jamming surfaces and also a circular jamming receptacle are expedient.

Even though it is fundamentally possible for the latching or jamming projections and the latching and jamming receptacles to be designed so as to have only small production tolerances and even to enable centering of the body parts during assembly, one expedient refinement of the invention provides centering elements on both body parts. Said centering elements, which engage into one another for example slightly before or else at the same time as the latching or jamming parts are connected to one another as the body parts are assembled, enable an exact alignment of the body parts with respect to one another. Furthermore, it is not necessary to allow for a high tolerance during the formation of the latching or jamming projections and latching and jamming receptacles.

The centering elements may be designed as peg-like projections and interact with corresponding centering guides as the body parts are assembled. Two different embodiments are conceivable here. Firstly, the centering guides may be formed as blind holes which thus run as closed, hollow cylindrical bores into the material of one body part and into which the projections fully engage. It is alternatively also possible for the centering guides to be designed as groove-like recesses, which are open to the side, on the outer side of a body part, into which recesses the centering projections are pushed.

The latching or jamming action leads to a firm and substantially sealed connection or contact of the two body halves with respect to one another, such that no escape of lubricant or only an insignificant escape of lubricant occurs during the operation of the ball screw. To hereby now fully prevent an escape of lubricant from the deflecting channel between the body parts, one expedient refinement of the invention provides that one body part has provided on it, on its end side which points toward the other body part, a projection which extends at least over a part of the length of the end side, if appropriate over the entire length, and which engages in a positively locking manner over the other body part. Said projection engages over or overlaps the other body part, that is to say the connecting region between the body parts is additionally engaged over by said projection, with the projection bearing in a positively locking manner, that is to say sealingly, against the other body part. The other body part expediently has provided on it an end-side groove or recess into which the projection engages. The projection is thus virtually provided as an extension of the outer side of one body part at the end side thereof, and a corresponding recess or groove into which the projection is guided during the assembly process is provided on the other body part. As a result, despite the overlap, a planar, homogeneous outer side is provided.

In addition to the deflecting body itself, the invention also relates to a ball screw comprising a threaded spindle and a threaded nut which is movably mounted on said threaded spindle by means of balls, on which is provided at least one deflecting body of the type according to the invention.

### BRIEF DESCRIPTION OF THE DRAWING

An exemplary embodiment of the invention is illustrated in the drawing and is described in more detail below. In the drawing:

FIG. 1 shows a deflecting body composed of two body parts before assembly;

FIG. 2 shows a perspective view of one of the body parts from FIG. 1;

FIG. 3 shows a top view of a deflecting body of a second embodiment;

FIG. 4 shows a view of a body part from FIG. 3;

FIG. 5 shows a top view of a deflecting body of a third embodiment according to the invention;

FIG. 6 shows a partial view of a deflecting body in section with overlapping body parts.

### DETAILED DESCRIPTION OF THE DRAWING

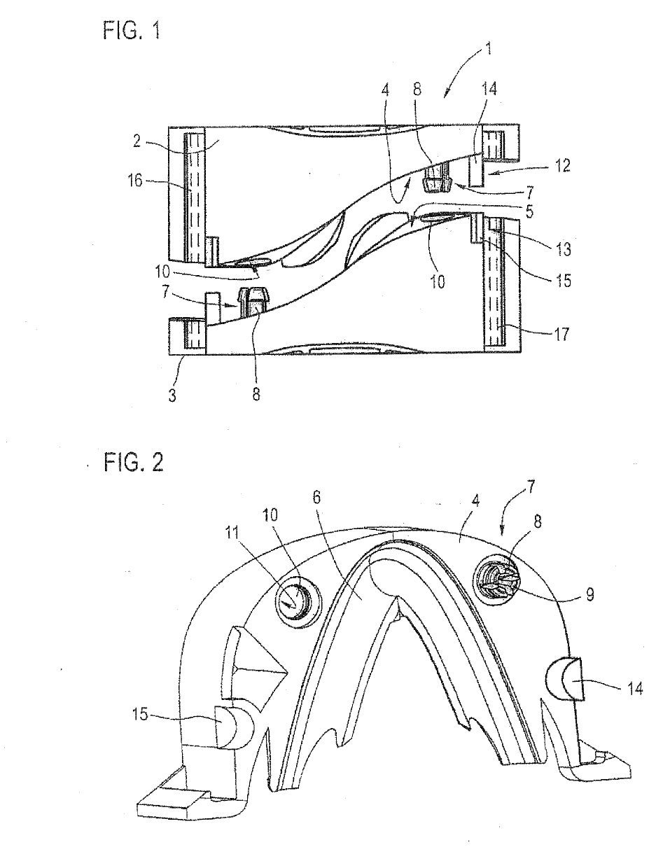

FIG. 1 shows a deflecting body 1 according to the invention comprising a first body part 2 and a second body part 3. Provided on the end surfaces 4, 5 of each body part 2, 3 is a channel section 6, wherein in the assembled position, the two channel sections 6 complement one another to form a deflecting channel. FIG. 1 shows the two body parts 2, 3 in the separated position.

In the exemplary embodiment shown in FIGS. 1 and 2, in order to firmly connect the body parts 2, 3 to one another as is necessary for transportation and for assembly purposes, a plurality of latching projections 7, which are resilient latching lugs 8, are provided on each end side 4, 5 at one side. In the exemplary embodiment shown, in each case four latching lugs 8 are arranged adjacent to one another. The upper latching sections 9 of said latching lugs 8 complement one another to form a round, mushroom-shaped geometry, as it were. Since the latching lugs 8 and also the body parts 2, 3 themselves are composed of plastic, they are inevitably slightly flexible and can snap into corresponding latching receptacles.

A corresponding latching receptacle 10 is formed on the respective opposite end surface 4, 5 of each body part 2, 3. The latching receptacle 10 has a corresponding undercut 11. For assembly, the two body parts 2, 3 are now moved together axially such that the latching lugs 8 are inserted into the respective opposite latching receptacle 10. Here, the slightly inclined latching sections 9 are pushed inward, as a result of their geometry, by the undercut latching receptacle 10, that is to say the diameter of the latching receptacle 10 is smaller than the diameter of the latching lug group or of the circular arrangement thereof. Said latching sections are thus bent slightly inward or towards one another. When the end position is reached, that is to say when the two end surfaces 4, 5 come to bear against one another, the latching sections 9 reach the respective undercut 11, and thus return into their initial position. The two body parts 2, 3 are consequently firmly latched to one another, with in each case one latching point being realized on the body part 2 and another latching point being realized on the body part 3.

It is self-evidently also possible to provide for example only two or three latching lugs 8; their latching sections 9 are preferably then likewise rounded in the shape of a circle in order to interact with a cylindrical latching receptacle 10.

To enable a centering action which ensures that the two body parts 2, 3 are positioned exactly with respect to one another and the latching projections 7 are inserted into the latching receptacles 10, centering elements 12, 13 are provided on the two body parts 2, 3. The centering elements 12 are projections 14, with in each case one projection being provided on a body part 2, 3. The centering elements 13 are formed as centering guides 15 which are open to the outside or at the edge. The geometry of the centering projections 14, which are of peg-shaped design, corresponds to the geometry of the centering guides 15 so as to enable positionally accurate centering and guidance with an accurate fit.

In the latched position, the end surfaces 4, 5 bear against one another substantially without a gap. That is to say that substantially sealing contact is realized, such that no significant escape of lubricant through the gap need be dealt with.

Provided laterally on the body parts 2, 3 are grooves 16, 17 into which corresponding retaining clamps engage in order to fix the deflecting bodies 1 in a threaded nut. The retaining clamp runs to another deflecting body and clamps the latter with its other end.

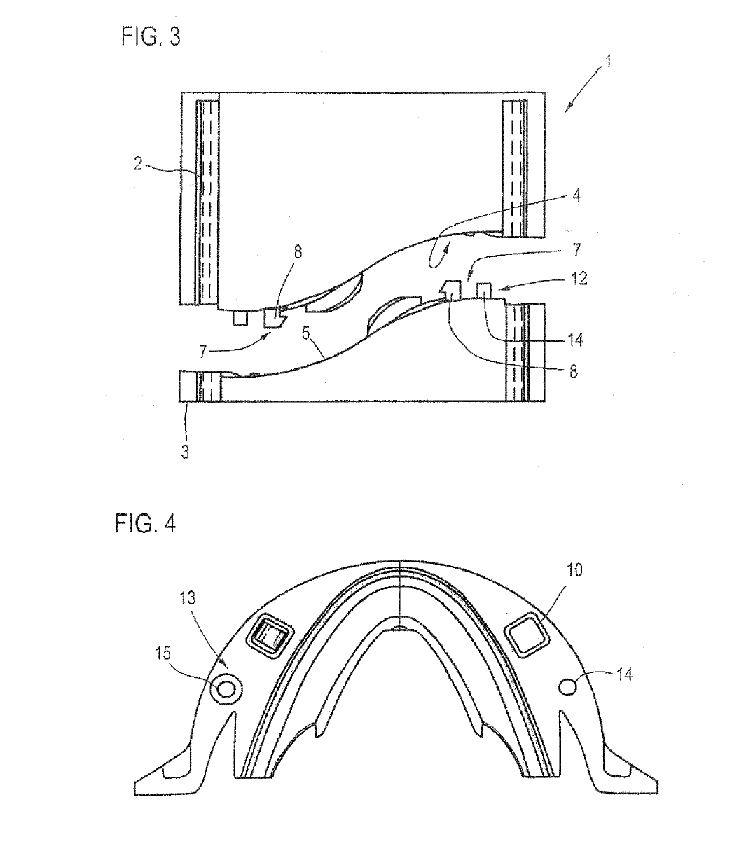

FIGS. 3 and 4 show a further embodiment of a deflecting body 1 according to the invention, with the same reference numerals being used to denote identical components. Here, too, use is made of two body parts 2, 3, with in each case one latching projection 7 in the form of in each case one latching lug 8 being provided on in each case one end surface 4, 5. Provided on the respective opposite end side is a likewise undercut latching receptacle 10 which, in the example shown, since in each case one latching lug is involved, is of substantially rectangular shape here.

In order to fasten the parts, here too an actual mechanical latching connection is produced to when the two body parts 2, 3 are in their end position.

Centering elements 12, 13 are provided here too, with the respective centering element 12, in each case one of which is provided on a body part 2, 3 here too, likewise being designed as a peg-shaped projection 14 while the other centering element is designed here as a hollow cylindrical blind bore or through bore 15. It is thus the case here that the centering bore is provided in the body part, while said centering bore is provided at the edge in the embodiment according to FIG. 2.

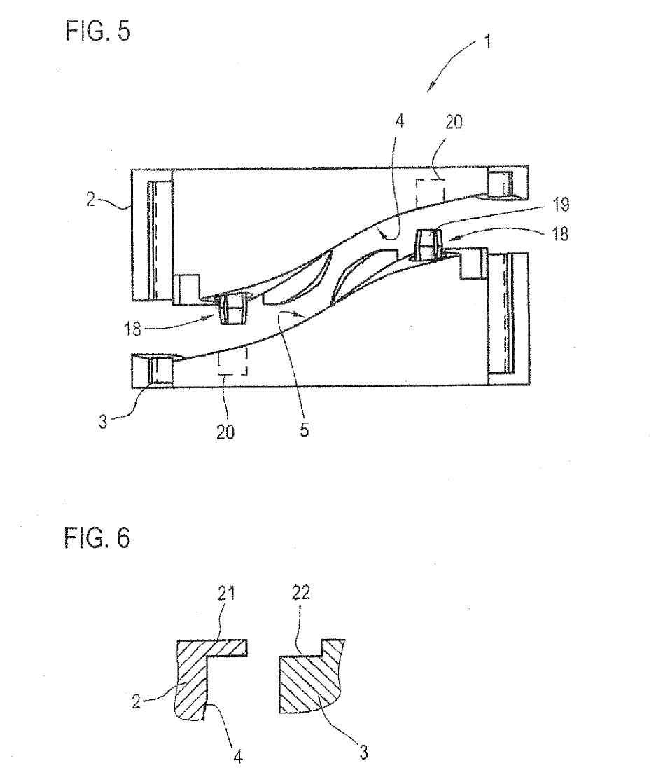

FIG. 5 shows a further deflecting body 1 according to the invention composed of the body parts 2, 3, wherein here, in contrast to the other embodiments, jamming projections 18 are provided on in each case one end side 4, 5. The jamming projections 18 are formed here as resilient jamming tongues 19, wherein said jamming tongues, for example in each case three or four thereof, are provided in a substantially circular or mushroom-shaped arrangement, or are formed with a curved outer side. Said jamming tongues have a slightly angled outer surface.

Provided on the opposite end side is in each case one jamming receptacle 20 which is illustrated here merely by dashed lines. To connect the body parts 2, 3, the jamming projections 18 or jamming tongues 19 are inserted into the jamming receptacle 20. The inner diameter of the hollow cylindrical jamming receptacles 20 is smaller than the outer diameter of the resilient jamming tongue arrangement. During the insertion, the jamming tongues 19 deflect inwards, guided by the wall of the jamming receptacle 20. A firm, frictionally acting connection is produced which fastens the two body parts 2, 3 axially. Here, the centering takes place directly by means of the jamming projections 18 and the jamming receptacles 20, and additional centering elements are not required here.

Finally, FIG. 6 shows a schematic diagram of partial views of the body parts 2, 3, with a narrow edge-side projection 21 which runs at least over a part of the length of the end surface 3 being provided on the body part 2. A corresponding recess and groove 22 is provided on the body part 3. In the assembled position, the projection 21 is held in a positively locking manner in the recess or groove 22. Additional safeguarding against an escape of lubricant in this region is realized in this way.

As already stated, the body parts 2, 3 are preferably produced from plastic, preferably in an injection-molding process. This makes it possible for the latching or jamming projections 7, 18 and the latching or jamming receptacles 10, 20 to be formed in a simple manner.

### LIST OF REFERENCE NUMERALS

1 Deflecting body
2 Body part
3 Body part
4 End surface
5 End surface
6 Channel section
7 Latching projection
8 Latching lug
9 Latching section
10 Latching receptacle
11 Undercut
12 Centering element
13 Centering element
14 Projection
15 Centering guide
16 Groove
17 Groove
18 Jamming projection
19 Jamming tongue
20 Jamming receptacle
21 Projection
22 Groove

1. A deflecting body for a ball screw, comprising:
two body parts connected to one another which delimit a deflecting channel which carries rolling bodies,
wherein latching projections or jamming projections are provided on one or both of the body parts, and the latching projections or the jamming projections, in an assembled final position, latch in a positively locking manner or are jammed in a frictionally engaging manner in latching receptacles or jamming receptacles provided on the other of the body parts.

2. The deflecting body of claim 1, wherein the latching projections are resilient latching lugs which latch into correspondingly undercut latching receptacles.

3. The deflecting body of claim 2, wherein two or more of the latching lugs are arranged adjacent to one another and engage into a common latching receptacle.

4. The deflecting body of claim 1, wherein the jamming projections are resilient jamming tongues, with two or more jamming tongues being arranged adjacent to one another and engaging into a common jamming receptacle.

5. The deflecting body of the claim 1, wherein centering elements are provided on both of the body parts.

6. The deflecting body of claim 5, wherein the centering elements are peg-like projections which interact with centering guides as the body parts are assembled.

7. The deflecting body of claim 6, wherein the centering guides are blind holes or recesses, which are open to a side, on an outer side of a body part.

8. The deflecting body of the claim 1, wherein one of the body parts has, on an end side which points toward the other of the body parts, a projection which extends at least over a part of length of the end side and which engages in a positively locking manner over the other of the body parts.

9. The deflecting body of claim 8, wherein the other of the body part has an end-side groove or recess into which the projection engages.

10. A ball screw, comprising: a threaded spindle; and a threaded nut, which is movably mounted on the threaded spindle by means of balls, on which is provided at least one deflecting body according to claim 1.
